(19) United States
(12) Patent Application Publication
(10) Pub. No.: US 2005/0165331 A1
(43) Pub. Date: Jul. 28, 2005

(54) Healthful pillow with multiple functions

(76) Inventor: Pu-Ching Huang, Taipei (TW)

Correspondence Address: Wen-Rong Sheu, P.O. Box 72, Nan Kang, Taipei, 115, TW

(21) Appl. No.: 10/764,686

(22) Filed: Jan. 27, 2004

(51) Int. Cl. A61H 39/04

(52) U.S. Cl. 601/15; 601/134; 606/204

(57) ABSTRACT

A healthful pillow with multiple functions includes a pillow body and a massage pad. The pillow body is provided with a permanent magnet and the massage pad is provided with granule pieces. Each of the granule pieces at the periphery thereof has a retaining band for being fixed to the pillow body. The granule pieces of the massage pad can press acupuncture points of the head to attain an effect of finger pressing massage and the permanent magnet can generate magnetism to attain an effect of stimulating acupuncture points of the head.

### BACKGROUND OF THE INVENTION

1. Field of the Invention

The present invention is related to a healthful pillow with multiple functions and particularly to a healthful pillow, which can provide an effect of finger pressing massage for the head of a user.

2. Brief Description of Related Art:

Because we can relax ourselves and regulate functions of our bodies during sleep hours, good quality of sleep becomes vital in order to keep our bodies healthy. Usually, a pillow is placed under the head during sleeping and the head can be supported with the pillow to reduce burden of the head.

However, a traditional pillow merely offers the function of supporting the head but it is insufficient for the user to acquire a good sleep quality and relieve all day fatigue. Hence, a good pillow not only is capable of supporting the head of a user but also can relax nerves of the user and stimulate acupuncture points of his head.

In order to reach the preceding purpose, a conventional pillow, which is filled with particle like stuff such as green gram shells, Chinese medical crops or Chinese teas, was developed to stimulate acupuncture points of the head for soothing the fatigue of the user and allowing the user to fall asleep sedately.

However, the green gram shells, the Chinese medical shells or the teas filled in the aforesaid pillow have to be replaced after a period of time because the original stuff will become powdering due to friction. Under this circumstance, the original function may loss gradually.

### SUMMARY OF THE INVENTION

A main object of the present invention is to provide a healthful pillow with multiple functions such as finger pressing effect, soothing feeling of fatigue, promoting blood circulation at the head, anti-oxidization, preventing from disease, enhancing immunocompetence, avoiding allergy, cleaning breath and enhancing sleeping quality.

In order to achieve the preceding object, the healthful pillow with multiple functions according the present invention includes:
a pillow body, being provided a permanent magnet; and
a massage pad, being provided with granule pieces thereon with each of the granule pieces at the periphery thereof having a retaining band for being fitted to the pillow body;
whereby, the granule pieces of the massage pad can press acupuncture points of the head to attain an effect of finger pressing massage and the permanent magnet can generate magnetism to attain an effect of stimulating acupuncture points of the head.

### BRIEFE DESCRIPTION OF THE DRAWINGS

The detail structure, the applied principle, the function and the effectiveness of the present invention can be more fully understood with reference to the following description and accompanying drawings, in which:

FIG. 1 is a perspective view of a pillow with multiple functions for health according to the present invention;

FIG. 2 is an exploded perspective view of FIG. 1;

FIG. 3 is a sectional view of the pillow shown in FIG. 1; and

FIG. 4 is a perspective view illustrating the permanent magnet being disposed in the pillow body.

### DETAILED DESCRIPTION OF THE PREFERRED EMBODIMENT

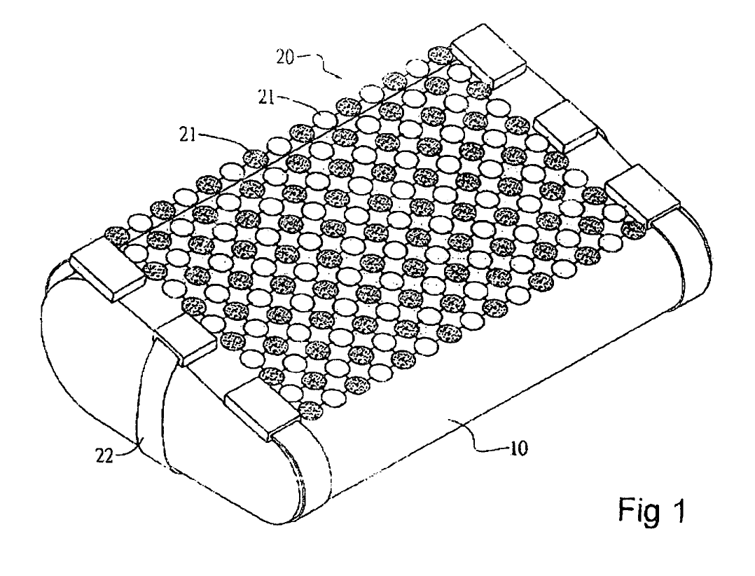

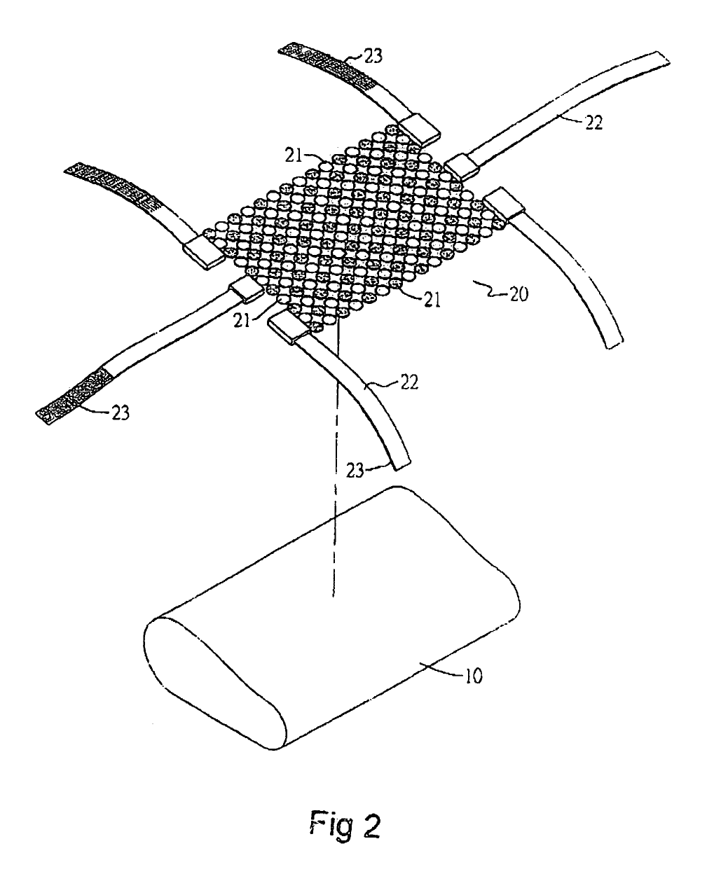

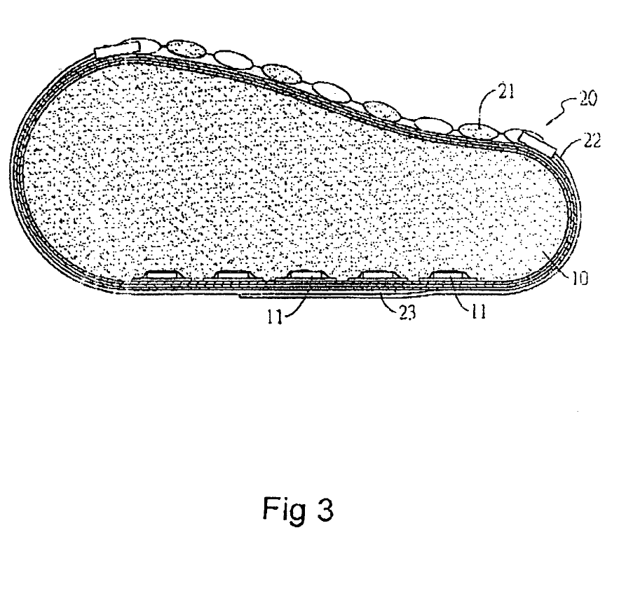

Referring to FIGS. 1 to 3, a pillow with multiple functions for health according to the present invention includes a pillow body 10 and a massage pad 20.

The pillow body 10 at the inner side thereof is provided with a permanent magnet 11 and the massage pad 20 is provided with granule pieces 21 thereon. Each of the granule pieces 21 at the periphery thereof has a retaining band 22 for being fitted to the pillow body 10.

The pillow body 10 can be formed with a gauze layer, a silk cotton layer, a far infrared non-woven cloth layer, a silk cloth layer and a dust resistant cloth layer. The silk cotton layer at the inside thereof can be filled with cotton to enhance softness of the pillow.

The granule pieces on the massage pad 20 can be bamboo balls, natural crystals or mixed bamboo balls and natural crystals and the retaining band 22 can be an elastic band, a cloth strip or a cord with a secure component 23 such as a male-female buckle or an adhesive cloth buckle such that the retaining band 22 can be engaged to facilitate the massage pad 20 being attached to the pillow body 10.

Further, the pillow body 10 can be received in a pillowslip (not shown), which is made of dust free material, so that it is possible for the pillow body 10 to prevent from being dirty.

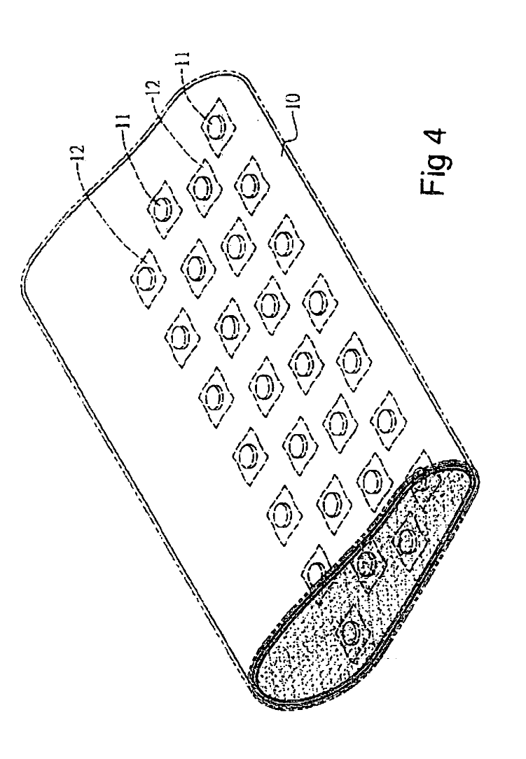

Referring to FIG. 4, the permanent magnet 11 can be enclosed in two cloth pieces 12, which are sewed up to the inner side of the pillow body 10. Alternatively, the two cloth pieces 12 receiving the permanent magnet 11 can be adhered to the inner side of the pillow body instead with the same effect.

In addition, the massage pad is detachably attached to the pillow body so that it is possible for the user to place the massage pad inside or outside the pillowcase base on the cold and the hot weather changes.

While the invention has been described with referencing to a preferred embodiment thereof, it is to be understood that modifications or variations may be easily made without departing from the spirit of this invention, which is defined by the appended claims.

1. A healthful pillow with multiple functions, comprising:
a pillow body, being provided a permanent magnet; and
a massage pad, being provided with granule pieces thereon with each of the granule pieces at the periphery thereof having a retaining band for being fitted to the pillow body.

2. The pillow with multiple functions for health as defined in claim 1, wherein the pillow body is composed of a gauze layer, a silk cotton layer, a far infrared non-woven cloth layer, a silk cloth layer and a dust resistant cloth layer.

3. The pillow with multiple functions for health as defined in claim 1, wherein a pillowslip is provided to receive the pillow body with the massage pad being detachably attached to an inner side or an outer side of the pillowslip for accommodating cold and hot weather changes.

4. The pillow with multiple functions for health as defined in claim 1, wherein the granule pieces of the massage pad are made of bamboo ball and natural crystal.

5. The pillow with multiple functions for health as defined in claim 1, wherein the retaining band of the massage pad is an elastic band, a cloth strip or a cord.

6. The pillow with multiple functions for health as defined in claim 1, wherein the retaining band of the massage pad is provided with a male-female buckle or an adhesive cloth band.

7. The pillow with multiple functions for health as defined in claim 1, wherein the permanent magnet is attached to an inner side of the pillow body in a way of the permanent magnet being enclosed with two thin cloth pieces and being sewed to or adhered to the inner side.
